(19) United States
(12) Patent Application Publication
(10) Pub. No.: US 2007/0027734 A1
(43) Pub. Date: Feb. 1, 2007

(54) Enterprise solution design methodology

(76) Inventor: Brian J. Hughes, Round Hill, VA (US)

Correspondence Address: PILLSBURY WINTHROP SHAW PITTMAN, LLP, P.O. BOX 10500, MCLEAN, VA, 22102, US

(21) Appl. No.: 11/194,231

(22) Filed: Aug. 1, 2005

(51) Int. Cl. G06F 17/50

(52) U.S. Cl. 705/7

(57) ABSTRACT

One method for implementing a solution design methodology includes receiving a request to evaluate a value chain associated with an enterprise. The value chain comprises activities. The enterprise is queried for information associated with the activities. A current maturity level of the value chain is identified based, at least in part, on the information. A process model is implemented for increasing the current maturity level.

### TECHNICAL FIELD

This invention relates to enterprise management and, more particularly, to solution design methodology for an enterprise.

### BACKGROUND

Providing goods and services typically requires an enterprise to perform multiple tasks or other entities to perform associated tasks. These tasks may include the use of software, hardware, or other technology. In addition, these tasks may also require that individuals perform certain management or supporting tasks. These tasks can be fairly complex requiring multiples steps and/or processes.

### SUMMARY

The present disclosure provides a solution design methodology or a system for implementing such a methodology. In one embodiment, a method includes receiving a request to evaluate a value chain associated with an enterprise. The value chain comprises activities. The enterprise is queried for information associated with the activities. A current maturity level of the value chain is identified based, at least in part, on information. A process model is implemented for increasing the current maturity level.

In another embodiment, a method includes identifying a value chain associated with enterprises, the value chain including a plurality of activities. A best practice associated with each activity is identified and a plurality of process models for increasing a maturity level of a particular value chain are developed.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a system for implementing methodologies of a value chain in accordance with one embodiment of the present disclosure;

FIG. 2 is an example flow diagram for developing process models in accordance with one embodiment of the present disclosure; and

FIG. 3 is an example flow diagram for customizing a process model in accordance with one embodiment of the present disclosure.

### DETAILED DESCRIPTION

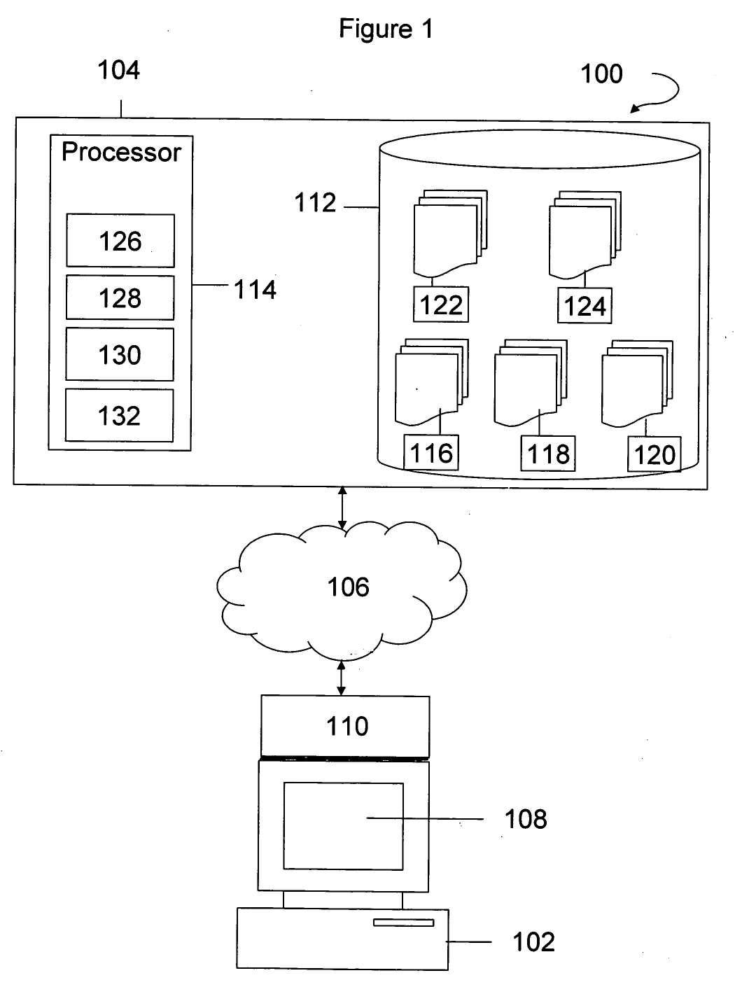

FIG. 1 is a system 100 for enhancing a value chain associated with an enterprise using developed process models. A value chain is typically a set of primary and secondary activities or other tasks or processes that the enterprise performs to turn inputs into a product and/or service for internal or external customers. The set of activities may include designing, procuring, producing, marketing, distributing, or servicing the product and/or the service. A process model is any components or techniques operable to upgrade, enhance, or otherwise improve the activities of the value chain. Such components and techniques may include or combine individuals, processes, and/or technology to achieve improvements. For example, technology is typically developed to include features and functions that are associated with a particular activity performed by the enterprise. Continuing the example, software may be developed to identify assets in the enterprise and the hardware and software associated with each asset. After technology is developed, the technology is then matched to particular customers. However, such technology is often limited to a single activity in the value chain and does not provide a customizable process for enhancing or improving the entire value chain. Accordingly, system 100 may customize and implement process models that enhance, improve, or otherwise increase the maturity level of the value chain associated with the enterprise. As a result, the enterprise may reduce, minimize, or eliminate costs associated with activities in the value chain or enhance or improve the associated activities.

The enterprise may implement system 100 to enhance the value chain using developed process models. In general, system 100 comprises any system operable to identify a current maturity level of a value chain and provide customizable process models to enhance, improve, or otherwise increase the maturity level of the value chain. More specifically, system 100 may be operable to assess, design, implement and optimize an information technology (IT) environment. For example, system 100 may help enable an employee, consultant, or other person to evaluate the current condition of the IT environment to identify and deliver recommendations for areas of improvement. Once evaluated, the person can create requirements-based best practices architecture that integrates processes, people, and technology. Next, system 100 helps leverage proven experience and best practices to ensure implementations that accelerate time-to-value of IT investments. System 100 is then operable to maximize or enhance the investment in IT by ensuring that the existing IT investment is optimally utilized. Additionally, system 100 may allow such a methodology to scale by controlling requirements or other inputs that are decomposed into a set of predetermined outcomes (or execution plans), which may be used multiple times as well as customized. To achieve this, system 100 is typically a client/server environment comprising at least one client 102 coupled to a model server 104 via a network 106, but system 100 may also be a stand-alone computing environment or any other suitable environment.

Client 102 is typically a computer that requests and receives services and information from server 104 via network 106. In the illustrated embodiment, client 102 includes a graphical user interface (GUI) 108 and an interface 110. It will be understood that there may be any number of clients 102 coupled to server 104 or, alternatively, client 102 may comprise a management or administrative component of server 104. In general, client 102 may include input devices, output devices, storage media, processors, memory, interfaces, communication ports, or other suitable components for communicating requests to server 104 and receiving responses via network 106. For example, client 102 may comprise a computer that includes an input device, such as a keypad, touch screen, mouse, or other device that can accept information and an output device that conveys information associated with the operation of server 104 or clients 102, including digital data, visual information, or any other suitable information. Both the input device and output device may include fixed or removable storage media such as magnetic computer disk, CD-ROM, or other suitable media to both receive input from and provide output to users of client 102 through a portion of a data display, namely GUI 108. As used in this document, client 102 is intended to encompass a personal computer, a workstation, network computer, kiosk, wireless data port, personal data assistant (PDA), one or more processors within these or other devices, or any other suitable processing device. Of course, the present disclosure contemplates computers other than general purpose computers as well as computers without conventional operation systems.

GUI 108 comprises a graphical user interface operable to allow the user of client 102 to interface with at least a portion of system 100 for any suitable purpose. Generally, GUI 108 provides the user of client 102 with an efficient and user-friendly presentation of data provided by system 100, such as charts and tables. GUI 108 may comprise a plurality of displays having interactive fields, pull-down lists, and buttons operated by the user. It should be understood that the term “graphical user interface” may be used in the singular or in the plural to describe one or more graphic user interfaces in each of the displays of a particular graphical user interface. Further, GUI 108 contemplates any graphical user interface, such as a generic web browser, that processes information in system 100 and efficiently presents the information to the user. Server 104 can accept data from client 102 via the web browser (e.g., Microsoft Internet Explorer or Netscape Navigator) and return the appropriate Hyper Text Markup Language (HTML) or extensible Markup Language (XML) responses.

As appropriate, client 102 generates requests and/or responses and communicates them to another client, server, or other computer systems located in or beyond network 106 such as, for example, server 104. For example, client 102 may receive or transmit data associated with a value chain associated with the enterprise. Client 102 may include network interface 110 for communicating with other computer systems over network 106 such as, for example, in a client-server or other distributed environment. Generally, interface 110 comprises logic encoded in software and/or hardware in any suitable combination to allow client 102 to communicate with network 106. More specifically, interface 110 may comprise software supporting one or more communications protocols and communications hardware operable to communicate physical signals between client 102 and server 104 over network 106. Network 106 facilitates wireless or wireline communication between computer system 100 and any other computer. Network 106 may communicate, for example, Internet Protocol (IP) packets, Frame Relay frames, Asynchronous Transfer Mode (ATM) cells, voice, video, data, and other suitable information between network addresses. Network 106 may include one or more local area networks (LANs), radio access networks (RANs), metropolitan area networks (MANs), wide area networks (WANs), all or a portion of the Internet, and/or any other communication system or systems at one or more locations.

Server 104 is a computer that aids in the evaluation of values chains associated with the enterprise and customizes process models 116 for the enterprise. In the illustrated embodiment, server 104 includes memory 112 and a processor 114 and comprises an electronic computing device operable to receive, transmit, process and store data associated with system 100. Although FIG. 1 provides one example of server 104 that may be used with the disclosure, server 104 can be implemented using computers other than servers, as well as a server pool. For example, server 104 may comprise a general-purpose personal computer (PC), a Macintosh, a workstation, a UNIX-based computer, a blade server, or any other suitable device. Server 104 may also comprise or include a web server. Server 104 may be adapted to execute any operating system including UNIX, Linux, Windows Server, z/OS, or any other suitable operating system. In one embodiment, server 104 does not allow direct access from an administrator or other user, but instead requires the administrator to securely log on through a standard web interface, such as the web browser described as GUI 108. This interface may provide summary information including enterprise evaluations, process models, customized implementations, and other information associated with the value chain. In short, server 104 may comprise software and/or hardware in any combination suitable to evaluate the value chain associated with the enterprise or distribute customized process models to enhance or improve the value chain.

Memory 112 may include any memory or database module and may take the form of volatile or non-volatile memory including, without limitation, magnetic media, optical media, random-access memory (RAM), read-only memory (ROM), removable media, or any other suitable local or remote memory component. While not required, illustrated memory 112 includes process models 116, reference architectures 118, reference implementations 120, evaluation files 122, and enterprise profiles 124, and may also include other appropriate files or data.

Process models 116 comprises any rules, instructions, algorithms, code, spreadsheets, flow charts, or other directives used by server 104 (or user thereof) to model methodologies that may improve the efficiencies and effectiveness of the value chain associated with the enterprise. For example, process model 116 may provide best practices for activities in the value chain. In some embodiments, process model 116 includes Information Technology Infracture Library (ITIL) processes or other workflows. In some embodiments, process model 116 includes Control Objectives for Information and related Technology (COBIT) processes or other workflows. In some embodiments, each process model 116 is associated with a maturity level such that applying process model 116 to the value chain with raise the value chain to the associated maturity level. The associated maturity level indicates the state of development of the value chain. For example, the value chain may not include any best practices as identified in the industry, so the maturity level of the value chain may, for example, be a one. After applying process model 116, the maturity level of the value chain may be raised to two or higher. In some embodiments, system 100 includes four process models 116 with each associated with a different maturity level such as one to four. Process model 116 may include directives for some or all activities in the value chain.

In some embodiments, process model 116 is an object-oriented model. In this case, the artifacts of the system may be specified, visualized, and/or documented using Unified Modeling Language (UML). As a result, process model 116 may model the value chain using object-oriented concepts. The methodologies included in process model 116 may be usable by humans, devices, or a combination of the two. While described in terms of UML, process model 116 may be stored or processed in any suitable format such as, for example, a text file, binary file, an XML document, a flat file, a comma-separated value (CSV) file, a name-value pair file, structured query language (SQL) table, one or more libraries, or others. Process model 116 may be dynamically created or populated by server 104, a third-party vendor, any suitable user of server 104, loaded from a template, or received via network 106. The term “dynamically” as used herein, generally means that the appropriate processing is determined at run-time based upon the appropriate information.

Illustrated memory 112 also includes reference architecture 118, which comprises rules, instructions, algorithms, code, or any other directives used by server 104 to implement an associated process model 116. Reference architecture 118 may be associated with a single or multiple process models 116 or process model 116 may be associated with multiple reference architectures 118. Reference architecture 118 may include or identify technology, processes, and/or people to implement the methodologies modeled by associated process model 116. For example, reference architecture 118 may include a workflow to replace an existing activity in the value chain and, thus, increasing the maturity level of the value chain. In some examples, reference architecture 118 may include or otherwise identify code that fixes, eliminates, minimizes, or otherwise addresses one or more vulnerabilities of an activity in the value chain. As with process model 116, reference architecture 118 may be any suitable format such as, for example, a text file, binary file, an XML document, a flat file, a CSV file, a name-value pair file, SQL table, one or more libraries, or others. Reference architecture 118 may be dynamically created or populated by server 104, a third-party vendor, any suitable user of server 104, loaded from a default file, or received via network 106.

The enterprise may replace or modify technology, processes and/or workflows in the reference architecture 118 to generate reference implementation 120. Based, at least in part, on reference architecture 118, reference implementation 120 comprises any rules, instructions, algorithms, code, or any other directives illustrating reference architecture 118 that has been customized and used by server 104 to implement the associated process model 116. For example, software included in the reference architecture 118 may be replaced with software provided by a different vendor. In another example, a workflow may be replaced or modified. Reference implementation 120 may also be any suitable format such as, for example, a text file, binary file, an XML document, a flat file, a CSV file, a name-value pair file, SQL table, one or more libraries, or others.

Evaluation profile 122 is any rules, instructions, algorithms, code, or any other directives used by server 104 to query client 102 regarding the value chain. For example, evaluation profile 122 includes directives used to determine technology, processes, and/or people employed in the value chain. Evaluation profile 122 may include one or more directives for each activity in the value chain. In some embodiments, evaluation profile 122 includes directives to identify software, vendors, and/or versions. Evaluation profile 122 may be any suitable format such as, for example, a text file, binary file, an XML document, a flat file, a CSV file, a name-value pair file, SQL table, one or more libraries, or others. Evaluation profile 122 may be dynamically created or populated by server 104, a third-party vendor, any suitable user of server 104, loaded from a default file, or received via network 106.

Illustrated enterprise profile 124 includes one or more entries or data structures that describes the value chain associated with the enterprise. For example, enterprise file 124 may identify technology, processes, and/or people employed in the value chain for the particular enterprise. Enterprise profile 124 may be stored in any suitable format such as, for example, an XML document, a flat file, CSV file, a name-value pair file, SQL table, or others. Indeed, each profile 124 may be a temporary or a persistent data structure without departing from the scope of the disclosure. Enterprise profiles 124 are typically generated or loaded based on data or other configuration information received or retrieved from client 102.

Illustrated server 104 also includes processor 114. Processor 114 executes instructions and manipulates data to perform the operations of server 104 such as, for example, a Central Processing Unit (CPU), an Application-Specific Integrated Circuit (ASIC) or a Field Programmable Gate Array (FPGA). Although FIG. 1 illustrates a single processor 114 in server 104, multiple processors 114 may be used according to particular needs and reference to processor 114 is meant to include multiple processors 114 where applicable. Illustrated processor 114 executes software, such as example gap profiler 126, maturity calculator 128, display engine 132, and return on investment (ROI) calculator 132. Gap profiler 126 is any software component operable to generate enterprise profile 124. As used herein, software generally includes any appropriate combination of software, firmware, hardware, and/or other logic. For example, gap profiler 126 (or other software components) may be written or described in any appropriate computer language including C, C++, C#, Java, J#, Visual Basic, assembler, Perl, any suitable version of 4GL, another language, or any combination thereof. Gap profile 126 receives and/or retrieves information from evaluation profile 122 and based, at least in part, on the information queries the enterprise. For example, gap profile 126 may generate a display and query the user of client 102 via, for example, GUI 108. In some examples, gap profiler 126 automatically access the enterprise and automatically determines the information in accordance with evaluation profile 122. Regardless, gap profile 126 stores the information in enterprise profile 124.

Maturity calculator 128 is any software component operable to determine the current maturity level of the value chain. For example, maturity calculator 128 may receive information from enterprise profile 124 and generate the current maturity level of the value chain based, at least in part, on the received information. The current maturity level may indicate that a gap needs to be filled in accordance with process models 116. For example, if the current maturity level is 0.6, then the value chain may need to be raised to at least level one to full in the gap in accordance with process model 116.

Display engine 130 is any software component operable to display process models 116 or information based on process models 116 to client 102 via GUI 108. After the current maturity level of the value chain is determined, display engine 130 may display process model 116 to client 102 indicating that the current maturity level may be increased by applying the display process model 116. Display engine 130 may display multiple process models 116 and may even provide a comparison between process models 116. In this case, the user of client 102 may select a particular process model 116 to apply to the value chain. In response to the selection from the user, display engine 130 may display reference architecture 118 via GUI 108 indicating a pre-generated implementation of process model 116. In the event that the user wants to customize reference architecture 118, display engine 130 may provide graphic elements that enable the user to customize technology, processes, and/or people included in the implementation of process model 116. For example, display engine 130 may provide fields, graphical buttons, a dropdown menu, or other elements that enable to the user to customize reference architecture 118. After customization, display engine 130 generates reference implementation 120 based, at least in part, on the selection from the user.

To enable evaluating process models 116, ROI calculator 132 is any software, component operable to determine a return on investment based, at least in part, on applying process model 116 to the value chain. ROI calculator 132 retrieves or other receives information regarding the current value chain from enterprise profile 124. In addition, ROI calculator 132 retrieves or otherwise receives information from an identified process model 116. Based on a before and after of the value chain, ROI calculator 132 determines the return on investment. For example, ROI calculator 132 may determine the cost saved by increasing the efficiencies in and the effectiveness of the value chain.

In one aspect of operation, process models 116 are developed in response to assessing, analyzing or otherwise identifying the value chain. For example, the value chain for maintaining the integrity of an enterprise network may be identified and process models 116 may be developed to improve or otherwise increase the maturity level of the value chain. As discussed above, the value chain includes a plurality of activities. In the example, the activities may include identifying assets of the enterprise network, identifying technology associated with each asset, identifying vulnerabilities associated with the technology and/or the assets, and deploying remediations to update the vulnerable technology and/or assets. Based on the one or more process models 116, reference architecture 118 is generated to implement the associated process models 116. Turning to the example, reference architecture 118 may entirely include or identify software from a specific vendor that improves the value chain. In this case, reference architecture 118 may include software that automatically identifies assets, associated technology, and vulnerabilities and automatically deploys remediations to fix or otherwise update the assets and technology. In response to a request from client 102, gap profiler 126 may retrieve information from evaluation profile 122 and generate a display via GUI 108 that queries the user of client 102 regarding the current value chain of the enterprise. In the example, gap profiler 126 may request information from the user regarding how the enterprise currently identifies assets, associated technology, and vulnerabilities and how the enterprise remediates the vulnerabilities. Gap profiler 126 stores the responses or information associated with responses in enterprise profile 124.

Based, at least in part, on enterprise profile 124, maturity calculator 128 determines a current maturity level of the value chain. In the remediation example, maturity calculator 128 may determine that the current value chain does not automatically monitor vulnerabilities and/or automatically remediate vulnerabilities. As a result, maturity calculator 128 may determine that the current value chain has a low maturity level such as 1.5. After determining the maturity level, display engine 130 may present process models 116 that improve or otherwise increase the maturity level of the current value chain. Again turning to the example, display engine 130 may provide the user of client 102 with process model 116, thereby enabling the enterprise to fill in the gap between maturity level 1.5 and 2.0. In addition, display engine 130 may display process models 116 that would enable the enterprise to raise the value chain to a maturity level of 3, 4, or higher. Of course, these maturity levels are for example purposes only. Returning to the example operation, display engine 130 may display reference architecture 118 based on selected process model 116, which may include a pregenerated implementation of the selected process model 116. In the remediation example, display engine 130 may present the user with software from a specific vendor that automates the appropriate activities in the value chain. In the event that the user of client 102 customizes reference architecture 118, display engine 130 generates reference implementation 120 based on selections by the user. Display engine 130 may present, via GUI 108, graphical elements such as fields, buttons, or drop-down lists that enable the user to further customize reference architecture 118. As to the example, the user may select software by another vendor to perform one or more of the enhancements of the value chain. When determining which process model 116 to select, the user may employ ROI calculator 132 to determine return on investments for implementing the selected process model 116. In the remediation example, the user may examine the cost-savings of enhancing the enterprise networks vulnerability management in accordance with process models 116. For instance, the user may determine that the enterprise may only receive a minimal return for filling in the gap but would receive a substantial return for increasing the maturity level of the value chain to 3.

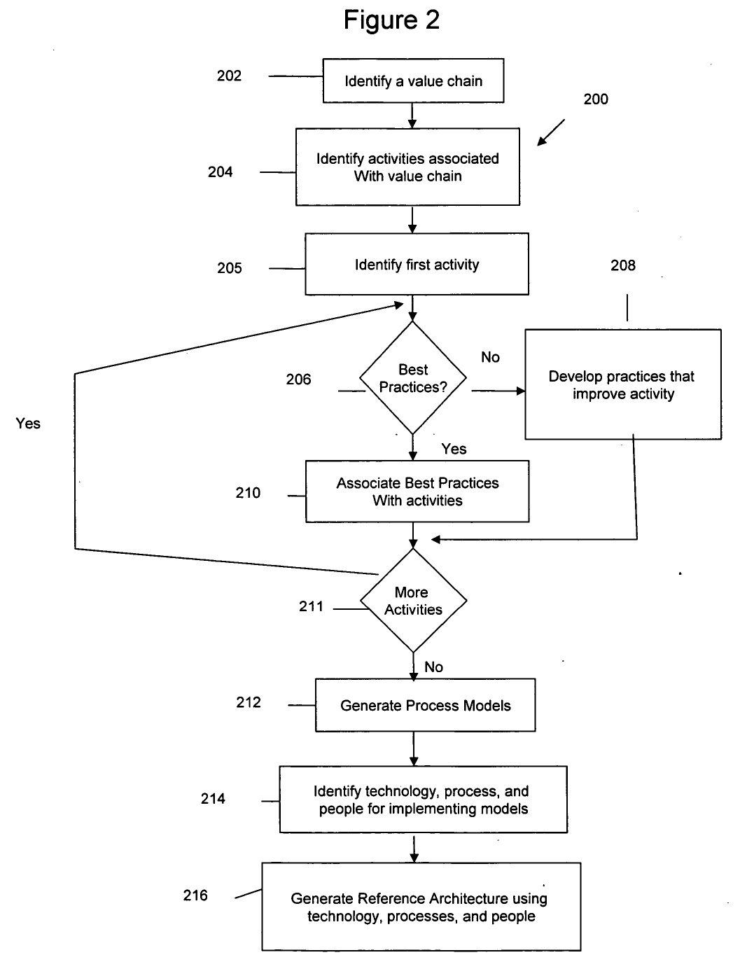

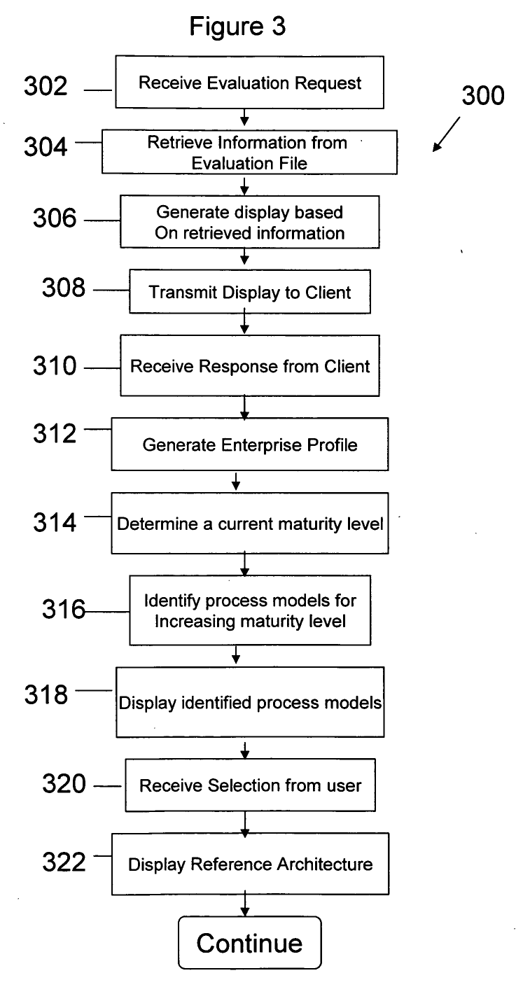

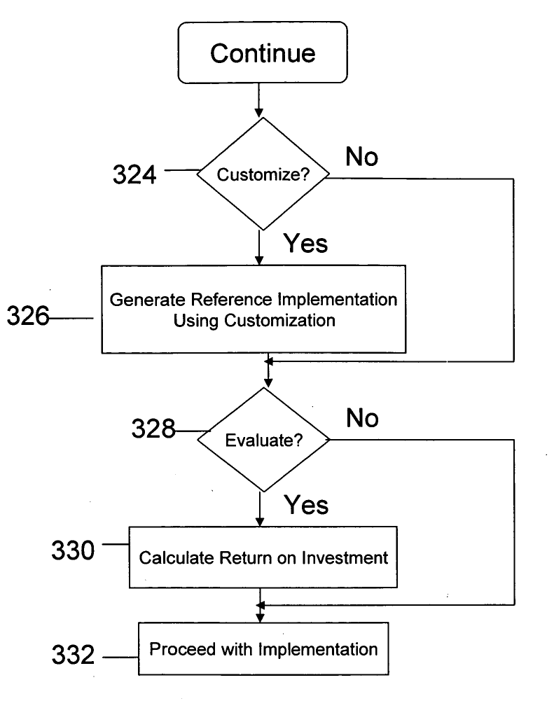

FIGS. 2-3 are exemplary flow diagrams illustrating methods for implementing process models 116. These methods are described with respect to system 100 of FIG. 1, but these methods could also be used by any other suitable system. Moreover, system 100 may use any other suitable technique for performing these tasks. Thus, many of the steps in this flowchart may take place simultaneously and/or in different orders as shown. Moreover, system 100 may use methods with additional steps, fewer steps, and/or different steps, so long as the methods remained appropriate.

FIG. 2 is an exemplary flow diagram illustrating a method 200 for developing process models for a value chain. Method 200 begins at step 202 where the value chain is identified. Next, at step 204, activities that are associated with the value chain are identified and the first of the activities is selected for analysis at step 205. If there are no known or suitable best practices, such as ITIL or COBIT, at decisional step 206, then, at step 208, methodologies are developed that would enhance or increase the maturity level of the value chain. If there are best practices at decisional step 206, then, at step 210, the best practices that are optimally associated with activities are identified. The steps continue for each activity as appropriate, as indicated by decisional step 211. Next, at step 212, process models 116 are generated or customized for the value chain using the established, generated, or otherwise identified practices. At step 212, technology, processes, and people are identified that may be used to implement these generated or customized process models 116. Using the identified technology, processes, and people, reference architecture 118 is developed. Such process models 116 may then reused across enterprises or other portions of the present enterprise, such as a department, subsidiary, client, and such.

FIG. 3 is an exemplary flow diagram illustrating a method 300 for implementing one or more process models 116. Method 300 begins at step 302, where server 104 receives a request to evaluate a value chain associated with all or any portion of the enterprise from client 102. For example, the value chain may include current methodologies or components associated with a certain logical or managerial structure within the enterprise such as IT. At step 304, gap profiler 126 retrieves information from evaluation file 122 and, at step 306, generates a display querying client 102 for information associated with the value chain. Gap profiler 126 transmits the display to the client 102 at step 308 and, at step 310, receives a response from the client 102. Based, at least in part, on the response, gap profiler 126 generates an enterprise profile 124 describing the various activities of the current value chain at 312. Next, at step 314, maturity calculator 128 determines a current maturity level of the value chain using enterprise profile 124. After determining the current maturity level, display engine 130 identifies process models 116 that may be operable to increase the current maturity level at step 316. Once identified, display engine 130 displays the identified process models 116 to the user of the client 102 at step 318. At step 320, display engine 130 receives a selection from the user. Based, at least in part, on the selection from the user, display engine 130 presents an associated reference architecture 118. If the user of client 102 customizes the associated reference architecture 118, display engine 130 generates reference implementation 120 using the identified customizations. If the user evaluates the selected implementation of process models 116 at decisional step 328, then ROI calculator 132 determines the return for investing in the implementation at step 330. At step 332, server 104 invokes the implementation to increase the maturity level of the value chain.

Although this disclosure has been described in terms of certain embodiments and generally associated methods, alternatives and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A method for enhancing a value chain, comprising:
identifying a value chain associated with an enterprise, the value chain including a plurality of activities;
identifying a best practice associated with a first of the activities; and
developing a process model for increasing a maturity level of the particular value chain using, at least in part, the identified best practice.

2. The method of claim 1, the best practice of the first activity conforming to Information Technology Infracture Library (ITIL) practice or Control Objectives for Information and related Technology (COBIT) practice.

3. The method of claim 1, further comprising associating each process model with an identified maturity level of the enterprise.

4. The method of claim 1, further comprising:
identifying at least one of a technology product, a business process, or a person operable to implement at least a portion of one process model to enhance the maturity level of activities associated with the portion; and
developing a reference architecture using the technology.

5. A method for enhancing an enterprise value chain, comprising:
receiving a request to evaluate a value chain associated with an enterprise, the value chain comprising a plurality of activities;
querying the enterprise for information associated with the activities;
identifying a current maturity level of the value chain based, at least in part, on the information; and
implementing a process model for increasing the current maturity level.

6. The method of claim 5, further comprising generating a profile of the value chain based on the information associated with the activities.

7. The method of claim 5, further comprising:
identifying process models associated with maturity levels greater than the current maturity level; and
displaying the identified models to the enterprise, the implemented process model comprising one of the displayed process models.

8. The method of claim 5, further comprising automatically identifying at least one of a technology product, a business process, or a person operable to implement at least a portion of one process model to enhance the maturity level of activities associated with the portion.

9. The method of claim 5, the process model comprising a UML model.

10. The method of claim 5, further comprising:
receiving a selection of the process model from a user in the enterprise;
identifying a reference architecture associated with the selected process model;
displaying the reference architecture to the enterprise; and
customizing the reference architecture based, at least in part, on a command from the user.

11. Software for enterprise management, the software comprising computer-readable instructions operable to:
receive a request to evaluate a value chain associated with an enterprise, the value chain comprising a plurality of activities;
query the enterprise for information associated with the activities;
identify a current maturity level of the value chain based, at least in part, on the information; and
implement a process model for increasing the current maturity level.

12. The software of claim 11, further operable to generate a profile of the value chain based on the information associated with the activities.

13. The software of claim 11, further operable to:
identify process models associated with maturity levels greater than the current maturity level; and
display the identified models to the enterprise, the implemented process model comprises one of the displayed process models.

14. The software of claim 11, further operable to identify at least one of a technology product, a business process, or a person operable to implement at least a portion of one process model to enhance the maturity level of activities associated with the portion

15. The software of claim 11, further operable to:
receive a selection of the process model from a user in the enterprise; and
identify a reference architecture associated with the selected process model;
display the reference architecture to the enterprise; and
customize the reference architecture based, at least in part, on a command from the user.

16. The software of claim 11, the process model comprising a UML model.

17. A system for enterprise management, comprising:
memory storing a plurality of process models; and
one or more processors operable to:
receive a request to evaluate a value chain associated with an enterprise, the value chain comprising a plurality activities;
query the enterprise for information associated with the activities;
identify a current maturity level of the value chain based, at least in part, on the information; and
implement one of the plurality of process models for increasing the current maturity level.

18. The system of claim 17, the processors further operable to generate a profile of the value chain based, at least in part, on the information associated with the activities.

19. The system of claim 17, the processors further operable to:
identify a subset of the stored process models, each of the subset associated with maturity levels greater than the current maturity level; and
display the identified subset to a user in the enterprise.

20. The system of claim 17, the processors further operable to:
receive a selection of the process model from a user in the enterprise;
identify a reference architecture associated with the selected process model;
display the reference architecture to the user through a secure interface; and
customize the reference architecture based, at least in part, on a command from the user.
